(19) United States
(12) Patent Application Publication
(10) Pub. No.: US 2018/0201802 A1
(43) Pub. Date: Jul. 19, 2018

(54) SELF-HEALING POLYURETHANE NANO-MICRO CAPSULES FOR AUTOMOTIVE PAINTING

(71) Applicant: GM Global Technology Operations LLC, Detroit, MI (US)

(72) Inventors: Carlos Y. Sakuramoto, Sao Paulo (BR); Agne Roani de Carvalho, Curitiba (BR); Marcel Andrey de Goes, Ponta Grossa (BR); Paulo Roberto Dantas Marangoni, Curitiba (BR); Marcos Antonio Coelho Berton, Curitiba (BR)

(21) Appl. No.: 15/408,859

(22) Filed: Jan. 18, 2017

(51) Int. Cl. C09D 129/04; C09D 7/14; C09D 11/00; B01J 13/18

(52) U.S. Cl. CPC C09D 129/04; B01J 13/18; C09D 11/00; C09D 7/14

(57) ABSTRACT

A self-healing paint and protective coating system includes multiple microcapsules embedded into a protective layer applied to a panel. Each of the multiple microcapsules includes a target substance and a polymeric material covering encapsulating the target substance. Upon activation of at least one of the multiple microcapsules occurring from a mechanical rupture of the polymeric material covering, the target substance is released.

### INTRODUCTION

The present disclosure relates to a procedure to synthesis microcapsules for addition to automotive paint and the microcapsules created thereby.

Metal panels used for example as body and trim panels for automobiles are commonly coated with a corrosion resistant material and painted to provide both aesthetic enhancement and to protect against corrosion. It is desirable to coat and pre-paint these panels during one of the pre-production steps. When the material of the panel is subsequently formed, however, for example during a trimming operation, the paint layer and the protective coating can be locally removed. Handling of the panel can also scratch the paint layer and the protective coating. If the protective coating is not replaced, subsequent corrosion damage can therefore occur at the sites of unprotected material. Subsequent damage to the paint layer and the protective coating can also occur such as by a scratch or stone chip during vehicle operation. Known vehicle paints and coatings do not provide the capability to “self-heal”, and therefore must be treated after damage to regain corrosion resistance. The term “self-heal” or “self-healing” is defined herein as a material's capacity to restore its structural integrity autonomously after having suffered damage.

Thus, while current vehicle coatings and paints achieve their general intended purpose, there is a need for a new and improved system and method for providing a self-healing capability.

### SUMMARY

According to several aspects, a self-healing paint and protective coating system includes multiple microcapsules embedded into a protective layer. Each of the multiple microcapsules, includes a target substance and a polymeric material covering encapsulating the target substance. Upon activation of at least one of the multiple microcapsules occurring from a mechanical rupture of the polymeric material covering, the target substance is released.

In an additional aspect of the present disclosure, the covering defines a polyurethane material.

In another aspect of the present disclosure, an average diameter of the microcapsules is approximately 15 μm.

In another aspect of the present disclosure, the target substance defines an automotive ink.

In another aspect of the present disclosure, the covering of the microcapsule has a varying thickness.

In another aspect of the present disclosure, wherein the microcapsules are formed using a microencapsulation chemical process.

In another aspect of the present disclosure, the microencapsulation chemical process defines in situ polymerization using a polycondensation reaction.

In another aspect of the present disclosure, the interfacial polymerization system provides for interfacial polymerization to occur at an interface between a first immiscible phase and a second immiscible phase.

In another aspect of the present disclosure, the first immiscible phase contains a first main reagent and the second immiscible phase contains a second main reagent.

In another aspect of the present disclosure, the first immiscible phase defines an organic phase.

In another aspect of the present disclosure, the organic phase is formed of a neutral surfactant with a core material defining the first main reagent, together with an aromatic diisocyanate monomer, acetone, and octanol.

In another aspect of the present disclosure, the second immiscible phase defines an aqueous phase.

In another aspect of the present disclosure, the aqueous phase is formed of an aqueous solution of an alcohol defining the second main reagent.

In another aspect of the present disclosure, the alcohol defines a poly(vinyl alcohol).

According to several aspects, a method for synthesizing microcapsules for inclusion into a protective coating, includes: creating an interfacial polymerization system having an organic phase and an aqueous phase; forming the organic phase of a neutral surfactant with a core material defining a first main reagent; preparing the aqueous phase as an aqueous solution of an alcohol; and stirring a mixture of the organic phase and the aqueous phase to form a plurality of microcapsules as an in situ polymerization defining a polycondensation reaction, each of the microcapsules having a portion of the first main reagent encapsulated by a polymeric material coating.

In another aspect of the present disclosure, the method for synthesizing microcapsules for inclusion into a protective coating further includes conducting the stirring step at a rate between approximately 200 rpm to 1800 rpm.

In another aspect of the present disclosure, the method for synthesizing microcapsules for inclusion into a protective coating further includes controlling a temperature of the mixture in a range between approximately 10° C. up to approximately 130° C.

In another aspect of the present disclosure, the method for synthesizing microcapsules for inclusion into a protective coating further includes continuing the stirring step for a time period ranging from approximately one (1) hour up to approximately twelve (12) hours.

In another aspect of the present disclosure, the method for synthesizing microcapsules for inclusion into a protective coating further includes adding an aromatic diisocyanate monomer, acetone, and octanol to the organic phase prior to the stirring step; inserting an automotive ink as the first main reagent; and embedding the microcapsules into an automotive paint.

According to several aspects, a method for synthesizing microcapsules for inclusion into a protective coating, includes: creating an interfacial polymerization system having an organic phase and an aqueous phase; forming the organic phase of a neutral surfactant with a core material defining a first main reagent, together with an aromatic diisocyanate monomer, acetone, and octanol; preparing the aqueous phase as an aqueous solution of an alcohol; stirring a mixture of the organic phase and the aqueous phase at a rate between approximately 200 rpm to 1800 rpm to form a plurality of microcapsules as an in situ polymerization defining a polycondensation reaction, each of the microcapsules having a portion of the first main reagent encapsulated by a polymeric material coating; andembedding the microcapsules into a protective coating wherein upon activation of at least one of the multiple microcapsules occurring from a mechanical rupture of the polymeric material covering, the first main reagent is released.

Further areas of applicability will become apparent from the description provided herein. It should be understood that the description and specific examples are intended for purposes of illustration only and are not intended to limit the scope of the present disclosure.

### BRIEF DESCRIPTION OF THE DRAWINGS

The drawings described herein are for illustration purposes only and are not intended to limit the scope of the present disclosure in any way.

FIG. 1A is a cross sectional view of a microcapsule according to an exemplary aspect of the present disclosure;

FIG. 1B is a cross sectional view of a known microsphere;

FIG. 2 is a cross sectional front elevational view of a microencapsulation chemical process involving in situ polymerization using a polycondensation reaction;

FIG. 3 is a graph presenting an infrared spectrum of a microcapsule prepared using the methods of the present disclosure compared to a hollow capsule as a control; and

FIG. 4 is a cross sectional front elevational view of a coating applied to a panel having multiple microcapsules of the present disclosure in the coating following mechanical rupture of the microcapsules and self-healing of the coating.

### DETAILED DESCRIPTION

The following description is merely exemplary in nature and is not intended to limit the present disclosure, application, or uses.

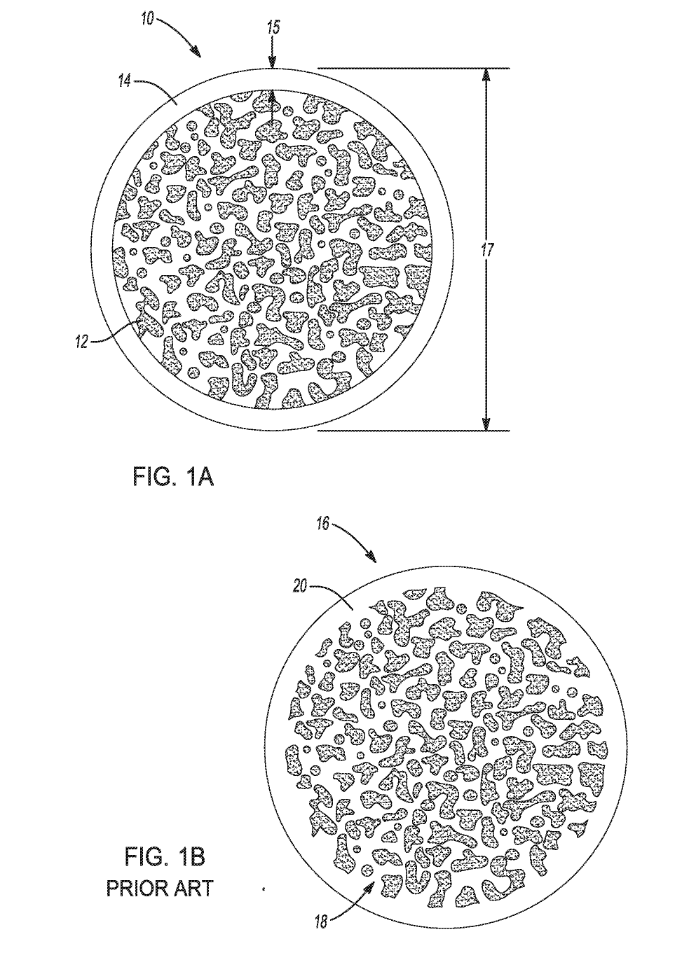

Referring to FIG. 1, a microcapsule for a self-healing coating paint and protective coating system of the present disclosure is generally depicted as item 10. The microcapsule 10 includes a target substance 12 such as for example an automotive ink, however the target substance 12 is not limited to the inclusion of automotive inks. The target substance 12 is encapsulated in a matrix or covering 14, which according to several aspects is a polymeric material including polyurethane. Multiple microcapsules 10 can be embedded for example into a protective layer such as a paint applied to an automobile vehicle panel, shown and described in greater detail in reference to FIG. 4. Upon activation of the microcapsule 10 which can occur from a mechanical rupture of the covering 14, the target substance 12 is released.

The covering 14 of the microcapsule 10 can have a varying thickness 15. A diameter 17 of the microcapsule 10 ranges between approximately 1 μm to approximately 1000 μm. Microcapsule size or diameter is therefore distinguished from a diameter of nanocapsules, which have a diameter smaller than 1 μm. The microcapsules 10 are generally spherical in shape, however the format regularity and the core dispersal will be influenced by physical and chemical characteristics of the target substance 12 to be encapsulated, and the method of encapsulation.

Referring to FIG. 1B and with continuing reference to FIG. 1A, the microcapsule 10 of the present disclosure is differentiated from a microsphere 16. The microsphere 16 is a matrix type of structure, with an active component 18 absorbed or covalently bonded to the material of a polymeric material 20. The active component 18 is physically distributed in a solid and substantially homogeneous matrix. After bonding, it is not possible to differentiate the active component 18 from the polymeric material 20, and it is therefore not possible to separately or distinctly release the active component 18.

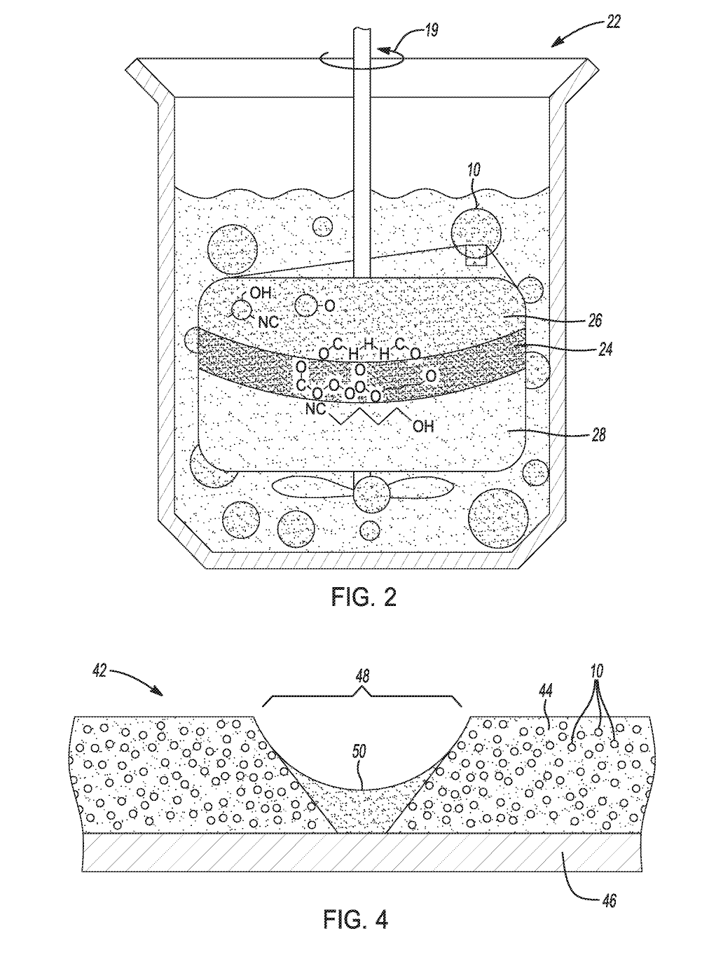

Referring to FIG. 2 and again to FIG. 1A, according to several aspects, microcapsules 10 are formed using a microencapsulation chemical process involving in situ polymerization using a polycondensation reaction. Polycondensation reactions can occur either through interfacial polymerization or by a polycondensation reaction in an emulsion. Interfacial polymerization has been found to be particularly effective for formation of the microcapsules 10 due to its relative simplicity and ease of application in an industrial scale production.

An interfacial polymerization system 22 provides for interfacial polymerization to occur at an interface 24 between a first immiscible phase 26 and a second immiscible phase 28, with the first immiscible phase 26 containing a first main reagent and the second immiscible phase 28 containing a second main reagent. According to several aspects, the first immiscible phase 26 defines an organic phase. To form the organic phase, a neutral surfactant is added, for example dibutyl sebacate, together with a core material defining the first main reagent, for example an automotive ink, and further with an aromatic diisocyanate monomer, acetone, and octanol. According to several aspects, the second immiscible phase 28 defines an aqueous phase. In one example, the aqueous phase can be formed of an aqueous solution of an alcohol such as but not limited to a poly(vinyl alcohol) (PVOH, PVA, or PVAI) having an idealized formula [CH₂CH(OH)]ₙ.

To control the core material droplet sizes in the first immiscible phase 26 and therefore to obtain droplets having a favorable size and a narrow distribution of particles, the microcapsule 10 size is determined based on several factors. These factors include the geometry of the stirring device, a viscosity, an interfacial tension between the organic phase and the aqueous phase, a stirring rate of the reagents, phase temperature, and a surfactant effect. It has been determined that a high stirring rate is highly effective. For example, the organic phase and the aqueous phase mixture is stirred in an exemplary stirring direction of rotation 19 at a rate between approximately 200 rpm to 1800 rpm. It has been further determined that a substantially fixed temperature of the thermostatic bath with a temperature controlled to range between approximately 10° C. up to approximately 130° C. is effective.

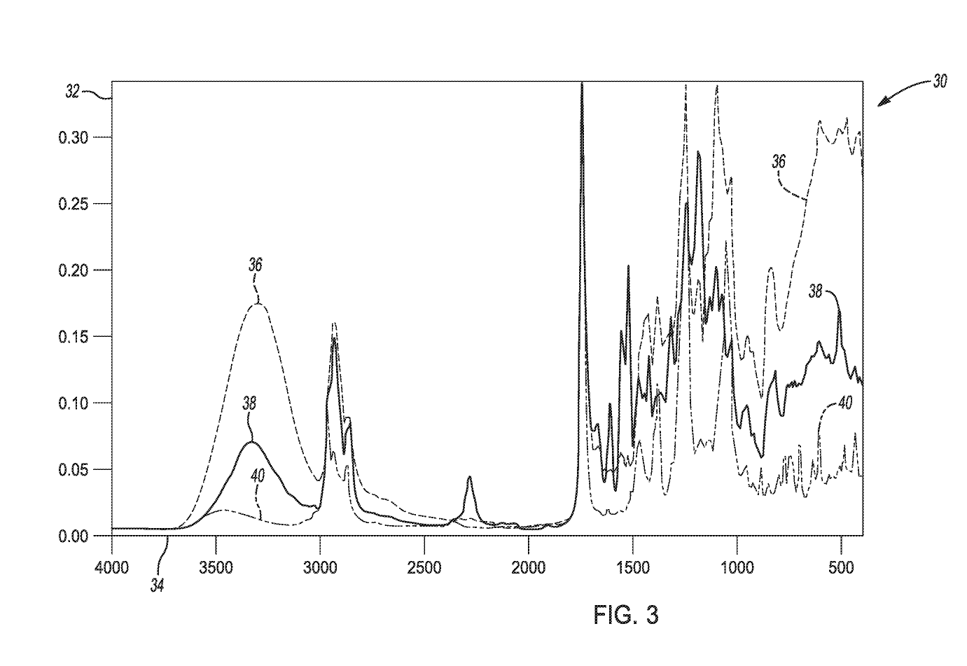

Referring to FIG. 3 and again to FIGS. 1A and 2, a graph 30 depicts on an ordinate 32 absorbance units and on an abscissa 34 a wavenumber quantity measured in cm⁻¹. Graph 30 depicts an infrared spectrum (FTIR) of synthesized microcapsules 10 in reactions having an automotive ink spectrum 36 compared to a spectrum 38 defining hollow microcapsules as a control, and a spectrum 40 of an automotive ink. FIG. 3 identifies that the hollow polyurethane microcapsule spectrum 38 provides characteristic bands of this compound class. Cited in this class are primarily an O—H stretch region of 3287 cm⁻¹ relative to the water present in the reaction medium; a C═O stretch characteristic of ester's carbonyl in the region of 1733 cm⁻¹, and bands in the region between 1509 cm⁻¹ to 1538 cm⁻¹, relative to C═C stretch bonds from aromatics, which result from those groups present on the polyurethane structure.

The automotive ink spectrum 40 shows volatile ester characteristic peaks, which are employed as solvents in the ink formulation (as butyl acetate for example), where it can be seen: C═O bond stretch on the region of 1733 cm⁻¹ and C—O bond stretch on the 1240 cm⁻¹ region, together with the C—H bond stretches between 2958 cm⁻¹ and 2933 cm⁻¹, which result from the hydrocarbon mixture employed in the ink formulation. The spectrum 36 of the microcapsules 10 containing automotive ink shows essentially the same representative bands as the automotive ink 40 and the hollow microcapsule 38 spectrums, indicating the core material (including the automotive ink) was incorporated.

Referring to FIG. 4, in an exemplary application of an automotive body panel 42, a plurality of the microcapsules 10 are embedded into a paint film 44 which directly contacts a substrate defining a body panel 46. Where a defect such as a scratch 48 removes a portion of the paint film 44, a plurality of the microcapsules 10 in the region of the scratch 48 rupture releasing a target substance or active component 50 defining in one example an automotive ink. The active component 50 is released and pools into the scratch 48, at least partially filling the scratch 50. The active component 50 reestablishes the protective qualities of the paint film 44, thereby self-healing the paint film 44.

A microcapsule synthesis procedure for self-healing coating applications of the present disclosure is characterized by the production of microcapsules by interfacial in situ polymerization, using a polycondensation reaction and having a polymeric material such as a polyurethane as a shell material. In a first step an organic phase is formed by mixing a neutral surfactant, such as dibutyl sebacate, an aromatic diisocyanate monomer, acetone or octanol. In a second step, an aqueous phase is formed by the addition of an alcohol, such as but not limited to polyvinyl alcohol in water.

In a following or third step, a microencapsulation reaction takes place by mixing the organic phase 26 and the aqueous phase 28 and stirring the mixture at a high rate, for example between approximately 200 rpm to 1800 rpm. In one aspect, the stirring rate is controlled to take place in a narrower range of approximately 500 rpm to approximately 1400 rpm.

It has been determined that the microencapsulation reaction also advantageously takes place in a thermostatic bath with a temperature controlled to range between approximately 10° C. up to approximately 130° C. In one aspect, the thermostatic bath temperature is controlled in a narrower range from approximately 30° C. up to approximately 90° C.

According to several aspects, the microencapsulation reaction occurs in a time period ranging from approximately one (1) hour up to approximately twelve (12) hours. In one aspect, the thermostatically controlled microencapsulation reaction is restricted to occur in a time ranging between approximately one and one half (1.5) to ten (10) hours. It has also been experimentally found that further enhancement of the microencapsulation reaction will occur using a restricted time period ranging from approximately three (3) to eight (8) hours. At the end of the microencapsulation process, the microcapsules 10 can be vacuum filtered or otherwise collected to be stored for use.

The present microencapsulation process using interfacial polymerization in situ and using polyurethane as a wall material for the covering 14 has been found to be efficient for preparing microcapsules 10 containing automotive ink. These microcapsules 10 were obtained with a substantially spherical morphology, filled with a narrow size distribution, and having an average diameter 17 of approximately 15 μm. The microcapsules 10 are therefore useful when incorporating automotive inks in order to obtain a smart coating having self-healing properties.

A self-healing paint and protective coating system and method for synthesis of the microcapsules thereof of the present disclosure offers several advantages. These include the production of microcapsules having a polymeric coating such as polyurethane which when ruptured releases a reagent encapsulated therein, where the reagent can include items such as automotive inks capable of self-healing a paint coating of an automotive feature. The microcapsules of the present disclosure can be easily manufactured using an interfacial in situ polymerization process using a polycondensation reaction on a large scale.

The description of the present disclosure is merely exemplary in nature and variations that do not depart from the gist of the present disclosure are intended to be within the scope of the present disclosure. Such variations are not to be regarded as a departure from the spirit and scope of the present disclosure.

What is claimed is:

1. A self-healing paint and protective coating system, including:
multiple microcapsules embedded into a protective layer, each of the multiple microcapsules, including:
a target substance; and
a polymeric material covering encapsulating the target substance;
wherein upon activation of at least one of the multiple microcapsules occurring from a mechanical rupture of the polymeric material covering, the target substance is released.

2. The self-healing paint and protective coating system of claim 1, wherein the covering defines a polyurethane material.

3. The self-healing paint and protective coating system of claim 2, wherein an average diameter of the microcapsules is approximately 15 μm.

4. The self-healing paint and protective coating system of claim 2, wherein the target substance defines an automotive ink.

5. The self-healing paint and protective coating system of claim 1, wherein the covering of the microcapsule has a varying thickness.

6. The self-healing paint and protective coating system of claim 1, wherein the microcapsules are formed using a microencapsulation chemical process.

7. The self-healing paint and protective coating system of claim 6, wherein the microencapsulation chemical process defines in situ polymerization using a polycondensation reaction.

8. The self-healing paint and protective coating system of claim 7, wherein the interfacial polymerization system provides for interfacial polymerization to occur at an interface between a first immiscible phase and a second immiscible phase.

9. The self-healing paint and protective coating system of claim 8, wherein the first immiscible phase contains a first main reagent and the second immiscible phase contains a second main reagent different from the first main reagent.

10. The self-healing paint and protective coating system of claim 9, wherein the first immiscible phase defines an organic phase.

11. The self-healing paint and protective coating system of claim 10, wherein the organic phase is formed of a neutral surfactant with a core material defining the first main reagent, together with an aromatic diisocyanate monomer, acetone, and octanol.

12. The self-healing paint and protective coating system of claim 9, wherein the second immiscible phase defines an aqueous phase.

13. The self-healing paint and protective coating system of claim 12, wherein the aqueous phase is formed of an aqueous solution of an alcohol defining the second main reagent.

14. The self-healing paint and protective coating system of claim 13, wherein the alcohol defines a poly(vinyl alcohol).

15. A method for synthesizing microcapsules for inclusion into a protective coating, including:
creating an interfacial polymerization system having an organic phase and an aqueous phase;
forming the organic phase of a neutral surfactant with a core material defining a first main reagent;
preparing the aqueous phase as an aqueous solution of an alcohol; and
stirring a mixture of the organic phase and the aqueous phase to form a plurality of microcapsules as an in situ polymerization defining a polycondensation reaction, each of the microcapsules having a portion of the first main reagent encapsulated by a polymeric material coating.

16. The method for synthesizing microcapsules for inclusion into a protective coating of claim 15, further including conducting the stirring step at a rate between approximately 200 rpm to 1800 rpm.

17. The method for synthesizing microcapsules for inclusion into a protective coating of claim 15, further including controlling a temperature of the mixture in a range between approximately 10° C. up to approximately 130° C.

18. The method for synthesizing microcapsules for inclusion into a protective coating of claim 15, further including continuing the stirring step for a time period ranging from approximately one (1) hour up to approximately twelve (12) hours.

19. The method for synthesizing microcapsules for inclusion into a protective coating of claim 15, further including:
adding an aromatic diisocyanate monomer, acetone, and octanol to the organic phase prior to the stirring step;
inserting an automotive ink as the first main reagent; and
embedding the microcapsules into an automotive paint.

20. A method for synthesizing microcapsules for inclusion into a protective coating, including:
creating an interfacial polymerization system having an organic phase and an aqueous phase;
forming the organic phase of a neutral surfactant with a core material defining a first main reagent, together with an aromatic diisocyanate monomer, acetone, and octanol;
preparing the aqueous phase as an aqueous solution of an alcohol;
stirring a mixture of the organic phase and the aqueous phase at a rate between approximately 200 rpm to 1800 rpm to form a plurality of microcapsules as an in situ polymerization defining a polycondensation reaction, each of the microcapsules having a portion of the first main reagent encapsulated by a polymeric material coating; and
embedding the microcapsules into a protective coating wherein upon activation of at least one of the multiple microcapsules occurring from a mechanical rupture of the polymeric material covering, the first main reagent is released.
